(19) United States
(12) Patent Application Publication
(10) Pub. No.: US 2002/0040380 A1
(43) Pub. Date: Apr. 4, 2002

(54) Program executing management system, a computer program product and a process executing management method

(76) Inventors: Shuji Harashima, Fuchu-shi (JP); Ikuya Odahara, Kawasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/873,251

(22) Filed: Jun. 5, 2001

(30) Foreign Application Priority Data
Jun. 6, 2000 (JP) 2000-168993

(51) Int. Cl. G06F 9/00

(52) U.S. Cl. 709/101

(57) ABSTRACT

This invention prevents complication of an application to reduce the labor of development and ensure normal processing. In this invention, a processing element definition unit stores the identification information and execution order of processing elements to be used, for each identification information of a process which sequentially uses a plurality of processing elements. A recovery processing element definition unit stores the identification information of a recovery processing element to be executed when an abnormality occurs, for each identification information of a processing element. An executing unit refers to the processing element definition unit on the basis of a processing element use request, and executes a processing element to be processed next. When an abnormality occurs during execution of a processing element, a recovery executing unit refers to the recovery processing element definition unit on the basis of the identification information of the processing element which has caused the abnormality, and executes a recovery processing element corresponding to the abnormality.

### CROSS-REFERENCE TO RELATED APPLICATIONS

This application is based upon and claims the benefit of priority from the prior Japanese Patent Application No. 2000-168993, filed Jun. 6, 2000, the entire contents of which are incorporated herein by reference.

### BACKGROUND OF THE INVENTION

Generally, a computer system executes a process required by the user by sequentially executing a plurality of transactions (meaningful processing units).

A general database management system (DBMS) also executes control by using transactions. For example, control of access to a database is-executed by transactions.

Assume that application programs for performing various services are service applications. An example of this service application is a process of making reservations by checking the reservation statuses of hotels and airline tickets. Transaction management is also used in these various service applications.

In transaction management in a computer system, it is important to ensure the following ACID (Atomicity, Consistency, Isolation, Durability) characteristics.

Atomicity is the characteristic which ensures that the transaction is executed or not at all executed.

Consistency is the characteristic which prevents conflicts in the contents of the database after the transaction is completed.

Isolation is the characteristic which protects the contents of a transaction being executed from being observed by other transactions.

Durability is the characteristic which prevents erasure of the result of a transaction that is completely executed.

As described above, the conventional computer system ensures the ACID characteristics and realizes normal processing for each transaction.

On the other hand, an object which a user requests a computer system to execute is a process of pursuing a service, i.e., a service application.

Accordingly, users often desire assurance whether all processes necessary for a service currently being pursued are executed or not.

Unfortunately, there is a big difference between transaction units provided by the system and service units. Also, items to be ensured differ from one service to another. Since this complicates the processing of a service application, the development of a service application requires much labor.

For example, the aforementioned service application for reserving hotels and airline tickets sometimes requires inputs by a human operator while this service is being pursued. That is, a human operator determines and inputs the reservation contents by monitoring the servation status on display.

When human determination exists during the course of pursuing a service as described above, the computer system generally handles the processes before and after the human input as different flows.

If the human operator gives no adequate instructions to the computer system, the process before the human input is executed, whereas the process after that is not executed, so the service is interrupted.

In the conventional computer system, such a service interruption is difficult to detect. Also, to prevent this service interruption, various exception handling processes and error checks must be inserted into a service application.

If, however, such exception handling processes and error checks are included in a service application, the service application is complicated.

### BRIEF SUMMARY OF THE INVENTION

It is an object of the present invention to provide a program executing management system, a program product, and a process executing management method using a computer system, each of which simplifies a process and at the same time ensures the normality of the process.

The first invention comprises a processing element definition unit for storing, for each identification information of a process which sequentially uses a plurality of processing elements, the identification information and execution order of a plurality of processing elements used in the process, a recovery processing element definition unit for storing the identification information of a recovery processing element to be executed when an abnormality occurs, for each identification information of the plurality of processing elements, an executing unit for referring to the processing element definition unit to obtain the identification information of a processing element to be processed next, on the basis of a processing element use request from the process, and executing the processing element corresponding to the obtained identification information, and a recovery executing unit for, when an abnormality occurs during execution of a processing element by the executing unit, referring to the recovery processing element definition unit on the basis of the identification information of the processing element which has caused the abnormality, and executing a recovery processing element corresponding to the abnormality.

In this first invention, a service is pursued by sequentially using processing elements. Also, in the first invention, a recovery processing element is defined for each of a plurality of processing elements. When an abnormality occurs, a recovery processing element corresponding to a processing element which has caused the abnormality is executed.

Accordingly, the normality of a process such as a service application can be ensured without including complicated exception handling processes and error checks in the process itself. This can reduce the labor of the development of a program.

In the second invention, the process in the first invention is executed by an application.

The third invention comprises a number issuing unit for, when an execution request for the process is generated, issuing an unique number corresponding to the execution request, in addition to the first invention. The executing unit identifies a processing element use request from the process for each unique number issued by the number issuing unit, manages the number of executed processing elements for each unique number, refers to the processing element definition unit on the basis of the number of executed processing elements to obtain the identification information of a processing element to be executed next, and executes the processing element corresponding to the obtained identification information.

In this third invention, a unique number is assigned to each execution request for a process, and the execution order of processing elements is managed for each execution request. Therefore, even when execution of the same process is requested a plurality of times, these executing processes can be individually managed and can also be individually restored even when an abnormality occurs.

The fourth invention comprises a processing element definition unit for storing, for each identification information of a process which sequentially uses a plurality of processing elements, the identification information and execution order of a plurality of processing elements used in the process, a recovery processing element definition unit for storing the identification information of a recovery processing element to be executed when an abnormality occurs, for each identification information of the plurality of processing elements, an executing unit for, when an execution request for the process is generated, referring to the processing element definition unit on the basis of the identification information of the process, and sequentially executing a plurality of processing elements corresponding to the identification information of the process in the execution order of the elements, and a recovery executing unit for, when an abnormality occurs during execution of a processing element by the executing unit, referring to the recovery processing element definition unit on the basis of the identification information of the processing element which has caused the abnormality, and executing a recovery processing element corresponding to the abnormality.

In this fourth invention, a plurality of processing elements are executed when execution of a process is requested once.

The fifth to eighth inventions are computer program products comprising program codes which implement functions similar to those of the units of the first to fourth inventions described above.

By using this computer program product, the above-mentioned functions can be easily added to a computer system, server, or the like not including.

The ninth embodiment is a computer-readable computer program product. The program product of this ninth invention comprises an executing code for referring to, on the basis of a process use request from a process which sequentially uses a plurality of processing elements, the identification information and execution order of a plurality of processing elements, stored for each piece of identification information of the process and to be used in the process, obtaining the identification information of a processing element to be processed next, and executing the processing element corresponding to the obtained identification information, and a result notification code for notifying the process of the result of execution of a processing element by the executing code.

By the use of this ninth invention, it is possible to execute part of a process by using a processing element and return the result to the process. Therefore, the labor of the development of a program concerning this process can be reduced.

A program product of the 10th invention comprises an input code for inputting the identification information of a process which sequentially executes a plurality of reusable processing elements, the identification information of a plurality of processing elements used in the process, and the execution order of the plurality of processing elements, and a definition code for storing, for each identification information of the process, the identification information of a plurality of processing elements used in the process, and the execution order of a plurality of processing elements used in the process.

The 11th invention comprises, in addition to the 10th invention, an executing code for, when the identification information of a process to be executed is input, referring to the contents defined by the definition code, and executing a processing element corresponding to the input identification information of the process in an execution order corresponding to the input identification information of the process, and a result notification code for notifying the process of the result of execution of a processing element by the executing code.

When these 10th and 11th inventions are used, it is possible to provide a service which sequentially executes those processing elements, of reusable processing elements, which a client wants to use. This allows easy development of a service application by the client.

The 12th to 14th inventions are process executing management methods using computer systems loading the programs according to the ninth to 11th inventions.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing an example of the configuration of a program executing management system according to the first embodiment of the present invention;

FIG. 2 is a flow chart showing an operation example of an input/output unit included in the program executing management system according to the first embodiment;

FIG. 3 is a flow chart showing an operation example of an executing control unit included in the program executing management system according to the first embodiment;

FIG. 4 is a flow chart showing an operation example of a number issuing unit included in the program executing management system according to the first embodiment;

FIG. 5 is a flow chart showing an operation example of an input/output unit included in a program executing management system according to the second embodiment of the present invention;

FIG. 6 is a flow chart showing an operation example of an executing control unit included in the program executing management system according to the second embodiment;

FIG. 7 is a block diagram exemplifying program codes included in a computer program product for implementing operations analogous to those of the program executing management system;

FIG. 8 is a block diagram exemplifying the state of a service provided by the program executing management system; and

FIG. 9 is a flow chart exemplifying an information processing service provided by the program executing management system.

### DETAILED DESCRIPTION OF THE INVENTION

Embodiments of the present invention will be described below with reference to the accompanying drawings.

(First Embodiment)

In this embodiment, a program executing management system in which a service application sequentially uses a plurality of processing elements to sequentially generate execution requests for these processing elements, thereby pursuing a service will be explained.

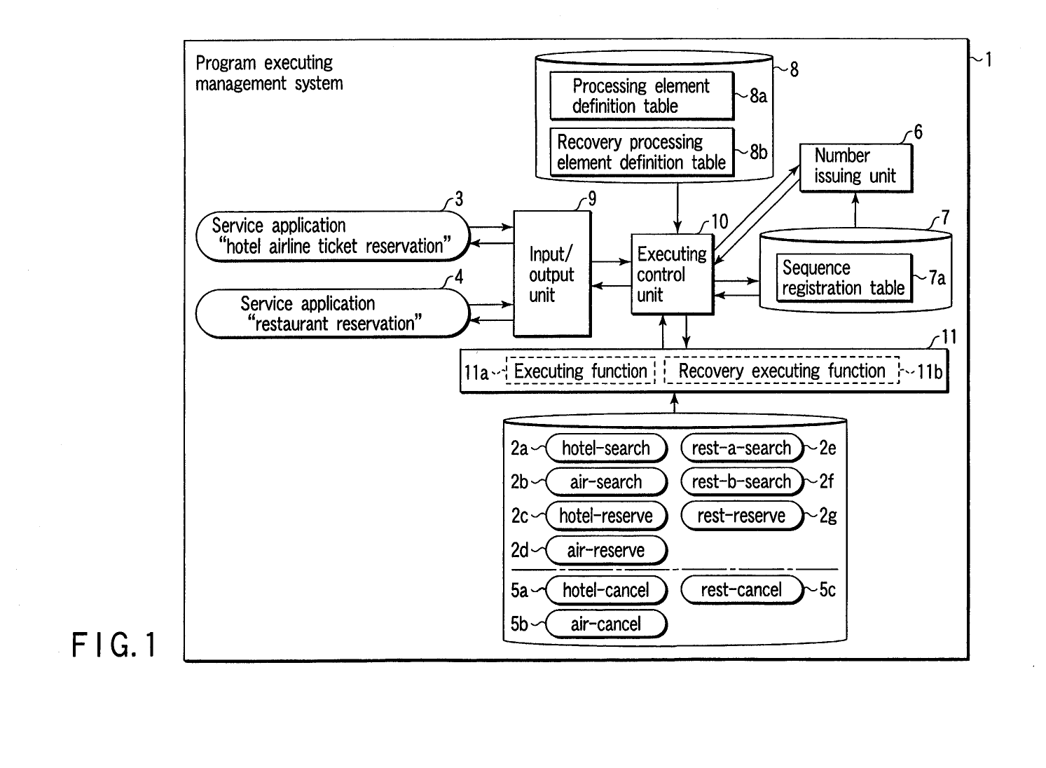

FIG. 1 is a block diagram showing an example of the configuration of the program executing management system according to this embodiment.

This program executing management system 1 includes a plurality of sequence processing elements 2a to 2g to be sequentially used, and service applications 3 and 4 which perform services by using these sequence processing elements 2a to 2g.

When using a sequence processing element for the first time in response to an execution request, the service application 3 or 4 outputs its type and data for the sequence processing element, and receives a number unique to the execution request and the execution result of the sequence processing element. After that, the service application 3 or 4 using the sequence processing element outputs the data and the previously input unique number, and receives the execution result of the sequence processing element.

Referring to FIG. 1, the service application 3 is a “hotel.airline ticket reservation” application. The service application 4 is a “restaurant reservation” application.

“Hotel-search” of the sequence processing element 2a is the process of searching and displaying the reservation status-* of hotels. “Air-search” of the sequence processing element 2b is the process of searching and displaying the reservation statuses of airline tickets. “Hotel-reserve” of the sequence processing element 2c is the process of reserving a hotel. “Air-reserve” of the sequence processing element 2d is the process of reserving an airline ticket. “Rest-a-search” of the sequence processing element 2e is the process of searching and displaying the reservation status of restaurant A. “Rest-b-search” of the sequence processing element 2f is the process of searching and displaying the reservation status of restaurant B. “Rest-reserve” of the sequence processing element 2g is the process of reserving a restaurant.

The program executing management system 1 further includes recovery processing elements 5a to 5c which, when any of the sequence processing elements ends an abnormally, execute a process of recovery from the abnormality.

Referring to FIG. 1, “hotel-cancel” of the recovery processing element 5a is the process of canceling a hotel reservation. “Air-cancel” of the recovery processing element 5b is the process of canceling an airline ticket reservation. “Rest-cancel” of the recovery processing element 5c is the process of canceling a restaurant reservation.

In addition, the program executing management system 1 includes a number issuing unit 6, a sequence registration unit 7, a definition storage unit 8, an input/output unit 9, an executing control unit 10, and a process executing unit 11. These units manage execution of a sequence processing element corresponding to an input from a service application. When an abnormality occurs, these units manage execution of the corresponding recovery processing element.

Whenever an execution request for a service application is generated, the number issuing unit 6 issues a number unique to this execution request.

The sequence registration unit 7 stores a sequence registration table 7a. This sequence registration table 7a manages, for each unique number of an execution request, the type of service application requested to be executed, and the final step number and status which indicate the degree to which a sequence processing element is executed.

The definition storage unit 8 stores a processing element definition table 8a and a recovery processing element definition table 8b.

The processing element definition table 8a manages, for each type of service application, the number of steps as the number of sequence processing elements to be used, and the types of sequence processing elements assigned step numbers on the basis of the execution order.

The recovery processing element definition table 8b manages, for each type of service application, the types of recovery processing elements corresponding to a step number at which an abnormality has occurred and the number of steps as the number of these recovery processing elements. The recovery processing element definition table 8b also assigns step numbers indicating the execution order to the types of recovery processing elements and thereby manages them.

Whenever a service application uses a sequence processing element, the input/output unit 9 receives the type or unique number of this service application and outputs the contents to the executing control unit 10. When receiving the execution result and unique number of a sequence processing element from the executing processing unit 10, the input/output unit 9 outputs the contents to the corresponding service application.

When receiving the type of service application newly requested to be executed via the input/output unit 9, the executing control unit 10 looks up the processing element definition table 8a on the basis of the type of this service application. The executing control unit 10 then causes the number issuing unit 6 to issue a number unique to the execution request, and registers this unique number in the sequence registration table 7a. Also, the executing control unit 10 instructs the process executing unit 11 to execute the first sequence processing element, and outputs the execution result and the unique number to the input/output unit 9.

On the other hand, when receiving an unique number from a service application not newly requested to be executed via the input/output unit 9, the executing control unit 10 looks up the processing element definition table 8a and looks up and updates the sequence registration table 7a on the basis of this unique number. The executing control unit 10 then instructs the process executing unit 11 to execute the next sequence processing element, and outputs the execution result to the input/output unit 9.

This executing control unit 10 also monitors the execution results of sequence processing elements and registers the results in the status of the sequence registration table 7a. If an execution result has an abnormality, the executing control unit 10 looks up the recovery processing element definition table 8b and instructs the process executing unit 11 to execute a recovery processing element to be executed.

The process executing unit 11 has an executing function 11a for executing a sequence processing element indicated by an execution instruction from the execution control unit 10 and outputting the execution result to the executing control unit 10.

The process executing unit 11 also has a recovery executing function 11b for executing a recovery processing element indicated by an execution instruction and outputting the execution result to the executing control unit 10.

Table 1 exemplifies the contents of the processing element definition table 8a described previously.

TABLE 1
Processing element definition table

| Type of | Number | Types of sequence |
|---|---|---|
| service | of | processing |
| application | steps | elements |
| Hotel • | 4 | 1. hotel-search |
| airline | | 2. air-search |
| ticket | | 3. hotel-reserve |
| reservation | | 4. air-reserve |
| Restaurant | 3 | 1. rest-a-search |
| Reservation | | 2. rest-b-search |
| | | 3. rest-reserve |

For example, in “hotel.airline ticket reservation” of the service application 3, “hotel-search” of the sequence processing element 2a, “air-search” of the sequence processing element 2b, “hotel-reserve” of the sequence processing element 2c, and “air-reserve” of the sequence processing element 2d are used in this order. In Table 1, therefore, the number of steps of sequence processing elements in “hotel.airline ticket reservation” is 4. Also, step numbers 1 to 4 are assigned to the types of sequence processing elements 2a to 2d, respectively.

Table 2 exemplifies the contents of the recovery processing element definition table 8b described previously.

TABLE 2
Recovery processing element definition table

| | | Number of | |
|---|---|---|---|
| | | steps of | |
| | Step number | recovery | Types of |
| Type of | of | processing | recovery |
| service | abnormality | elements to | processing |
| application | occurrence | be executed | elements |
| Hotel • | 1 | 0 | |
| air line | | | |
| reservation | | | |
| ditto | 2 | 0 | |
| ditto | 3 | 1 | hotel- |
| | | | cancel |
| ditto | 4 | 2 | 1. hotel- |
| | | | cancel |
| | | | 2. air- |
| | | | cancel |
| Restaurant | 1 | 0 | |
| reservation | | | |
| ditto | 2 | 0 | |
| ditto | 3 | 1 | 1. rest- |
| | | | cancel |

For example, if the sequence processing element 2d assigned step number 4 ends abnormally in “hotel.airline ticket reservation” of the service application 3, “hotel-cancel” of the recovery processing element 5a and “air-cancel” of the recovery processing element 5b are used in this order. In Table 2, therefore, the number of steps of recovery processing elements at step number 4 of “hotel•airline ticket reservation” is 2, and step numbers 1 and 2 are assigned to the types of recovery processing elements 5a and 5b, respectively.

Table 3 exemplifies the contents of the sequence registration table 7a described earlier.

TABLE 3
Sequence registration table

| Unique | | Final step | |
|---|---|---|---|
| number of | Type of | number | |
| execution | service | already | |
| request | application | executed | Status |
| 0001 | Hotel • | 3 | |
| | airline | (Hotel | |
| | reservation | reservation) | |
| 0002 | Restaurant | 4 | Completed |
| | reservation | | |

In this Table 3, an execution request having unique number “0001” is an execution request for “hotel.airline ticket reservation” of the service application 3. Also, information indicating that steps up to step number 3 of this execution request have been executed is stored together with the status at that point.

If a new “hotel.airline ticket reservation” execution request is generated, this execution request is similarly managed by an unique number different from that of the previously generated “hotel.airline ticket reservation”.

An operation example of the program executing management system 1 with the above arrangement will be described below.

Whenever requesting the use of a sequence processing element, the service application 3 or 4 outputs the type or unique number of the service application and, if necessary, data to the input/output unit 9, and receives the unique number and the execution result as a response to the output.

More specifically, when requesting the use of a sequence processing element for the first time, the service application 3 or 4 outputs its type and necessary data to the input/output unit 9, and receives the unique number and the execution result as a response from the input/output unit 9.

On the other hand, when using a sequence processing element not for the first time, the service application 3 or 4 outputs the unique number and necessary data to the input/output unit 9, and receives the execution result as a response from the input/output unit 9.

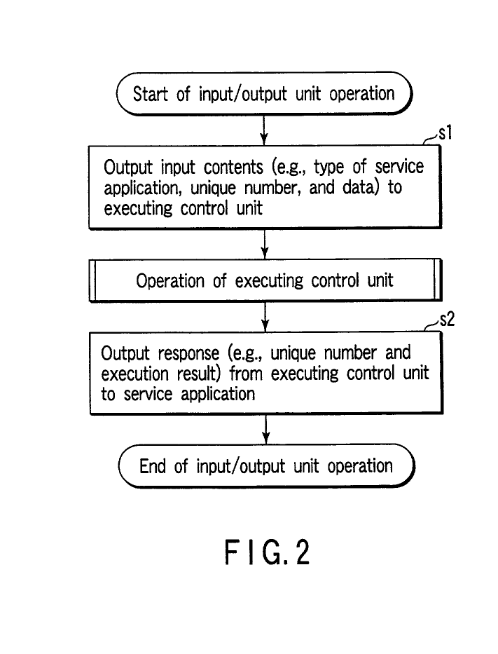

FIG. 2 is a flow chart showing an operation example of the input/output unit 9 included in the program executing management system 1 according to this embodiment.

This input/output unit 9 outputs the type or unique number of a service application, which is input from the service application, and necessary data to the executing control unit 10 (s1).

When the operation of this executing control unit 10 is completed, the input/output unit 9 receives the unique number and the execution result as a response from the executing control unit 10, and outputs this response to the service application that has requested the use of a sequence processing element (s2).

More specifically, when a sequence processing element is to be used for the first time, the input/output unit 9 receives the execution result and the unique number from the executing control unit 10, and outputs the execution result and the unique number to the service application that has requested the use of this sequence processing element. On the other hand, when a sequence processing element is to be used not for the first time, the input/output unit 9 receives the execution result from the executing control unit 10 after the operation of the executing control unit 10 is completed, and outputs the execution result to the service application that has requested the use of this sequence processing element.

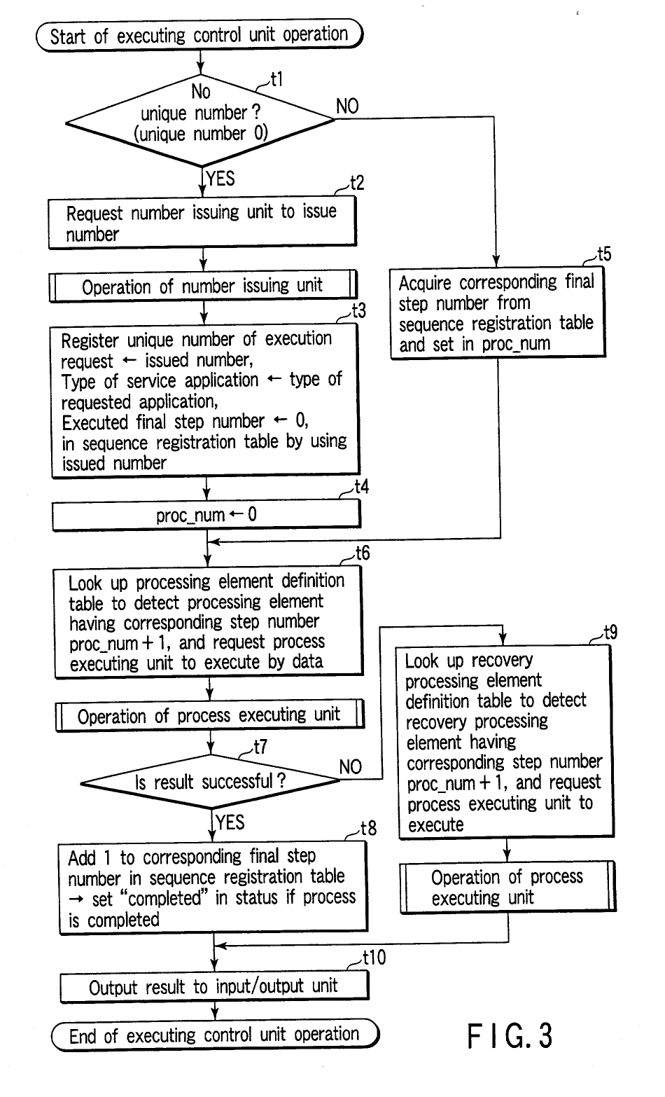

FIG. 3 is a flow chart showing an operation example of the executing control unit 10 included in the program executing management system 1 according to this embodiment.

This executing control unit 10 checks whether an unique number is contained in the input contents from the input/output unit 9 (t1).

If no unique number is contained in the input contents from the input unit 9 (if an unique number is 0), the executing control unit 10 requests the number issuing unit 6 to issue an unique number (t2). When the number issuing unit 6 issues an unique number, the executing control unit 10 newly registers this issued unique number in the sequence registration table 7a (t3), and sets 0 in proc_num which indicates the step number of a sequence processing element to be executed (t4).

If an unique number is contained in the input contents from the input unit 9, the executing control unit 10 looks up the sequence registration table 7a on the basis of this unique number, acquires the corresponding final step number, and sets this number as the value of proc_num (t5).

Then, the executing control unit 10 looks up the processing element definition table 8a on the basis of the unique number and the value of proc_num+1, and detects a sequence processing element having the same step number as the value of proc_num at this unique number. Also, the executing control unit 10 requests the process executing unit 11 to execute the detected sequence processing element by using data contained in the input contents from the input/output unit 9 (t6).

When the process executing unit 11 executes the corresponding sequence processing element, the executing control unit 10 checks whether the execution result is normal (t7).

If the execution result is normal, the executing control unit 10 looks up the sequence registration table 7a on the basis of the unique number. If the execution is completed, the executing control unit 10 registers this information in status (t8).

If the execution result is abnormal, the executing control unit 10 looks up the recovery processing element definition table 8b on the basis of the unique number and the value of proc_num, and detects a recovery processing element corresponding to the same step number as the value of proc_num+1 at this unique number. Also, the executing control unit 10 requests the process executing unit 11 to execute this detected recovery processing element (t9). As a consequence, the process executing unit 11 executes the corresponding recovery processing element.

The executing control unit 10 outputs the execution result to the input/output unit 9 (t10).

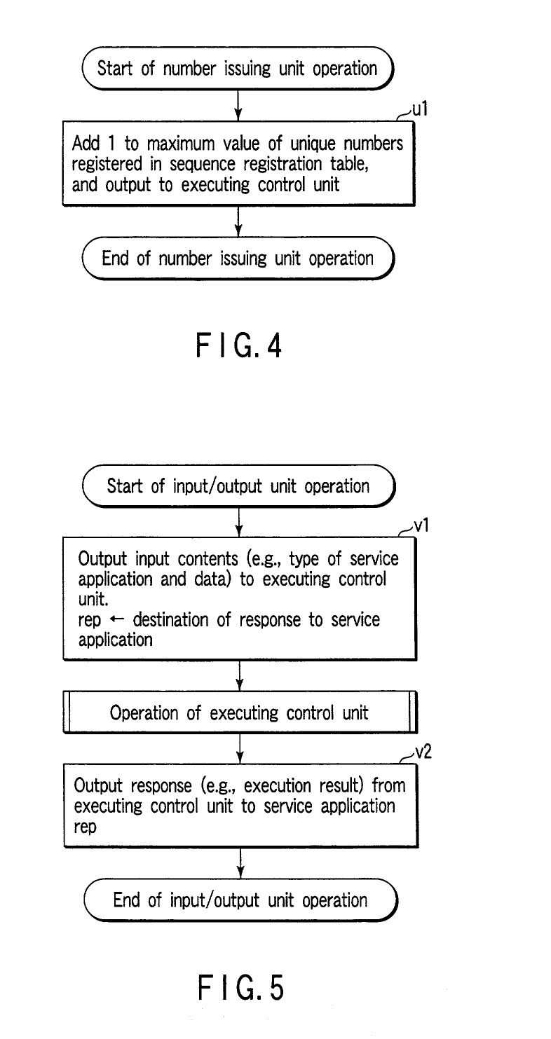

FIG. 4 is a flow chart showing an operation example of the number issuing unit 6 included in the program executing management system 1 according to this embodiment.

When requested to issue an unique number from the executing control unit 10, the number issuing unit 6 looks up the sequence registration table 7a and outputs to the executing control unit 10 a value obtained by adding 1 to the maximum value of unique numbers registered in the sequence registration table 7a as a new unique number (u1).

In the program executing management system 1 according to this embodiment as explained above, the service application 3 or 4 performs a service by sequentially using sequence processing elements. If abnormal end is detected, recovery is executed by a recovery processing element corresponding to an already executed sequence processing element.

As described above, processing elements are sequentially executed, and a process of recovery up to the occurrence of abnormality is separately prepared and executed. Therefore, exception handling processes for handling an abnormality and processes for error checks need not be contained in a service application when the application is developed.

This can prevent complication of a service application, reduce the labor of development, ensure the ACID characteristics concerning execution of services, and ensure the normality of service processing.

(Second Embodiment)

In the above first embodiment, a service application outputs data to an input/output unit whenever requesting the use of a sequence processing element.

This embodiment will describe a program executing management system in which a plurality of sequence processing elements are simultaneously executed in accordance with a request from a service application.

A program executing management system thus simultaneously executing a plurality of sequence processing elements in accordance with a request from a service application requires, of components shown in FIG. 1, a service application, a plurality of sequence processing elements and recovery processing elements, a definition storage unit, an input/output unit, an executing control unit, and a process executing unit. Of these components, the operations of primarily the service application, input/output unit, and executing control unit need only be changed.

Accordingly, the operations of a service application, input/output unit, and executing control unit included in a program executing management system according to this embodiment will be described below.

When using a sequence processing element, the service application outputs its type and, if necessary, data to the input/output unit, and receives the execution result as a response to the output.

FIG. 5 is a flow chart showing an operation example of the input/output unit included in the program executing management system according to this embodiment.

This input/output unit outputs to the executing control unit the service application type and necessary data input from the service application. At the same time, the input/output unit records the response destination of the result to the service application in rep (v1).

When the operation of the executing control unit is completed, the input/output unit receives the execution result as a response from the executing control unit, and outputs this response to the service application rep that has requested the use of a sequence processing element (v2).

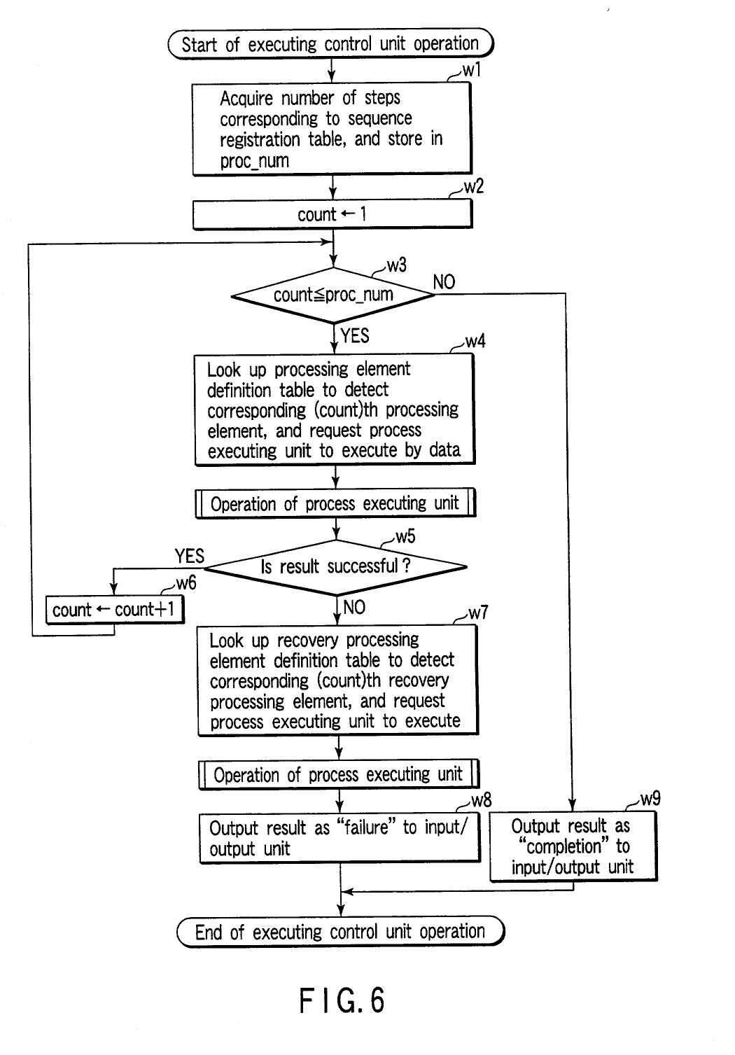

FIG. 6 is a flow chart showing an operation example of the executing control unit included in the program executing management system according to this embodiment.

This executing control unit looks up a sequence registration table 7a on the basis of the service application type input from the input unit, acquires the number of steps assigned to this service application type, and stores the number in proc_num which indicates the total number of sequence processing elements to be executed (w1).

Also, the executing control unit stores 1 in count as a counter variable (w2).

The executing control unit checks whether the value of count is equal to or less than the value of proc_num (w3).

If the value of count is equal to or less than the value of proc_num, the executing control unit looks up a processing element definition table 8a on the basis of the input service application type, and detects the (count)th sequence processing element assigned to this service application type. In addition, the executing control unit requests a process executing unit to execute the sequence processing element detected on the basis of the input data from the input/output unit (w4).

When the corresponding sequence processing element is executed by the process executing unit, the executing control unit checks whether the execution result is normal (w5).

If the execution result is normal, the executing control unit adds 1 to the value of count (w6) and again checks whether the value of count is equal to or less than the value of proc_num (w3).

If the execution result is abnormal, the executing control unit looks up a recovery processing element definition table on the basis of the service application type and the value of count, and detects a recovery processing element corresponding to the same step number as the value of count in the corresponding service application. Also, the executing control unit requests the process executing unit to execute the detected recovery processing element (w7).

Consequently, the process executing unit executes the corresponding recovery processing element, and the executing control unit outputs the execution result indicating “failure” to the input/output unit (w8).

On the other hand, if the executing control unit determines that the value of count is not equal to or less than the value of proc_num, the executing control unit outputs the execution result indicating “completion” to the input/output unit (w9).

In the program executing management system according to this embodiment as explained above, a service application need only output its own type to the input/output unit so that a plurality of sequence processing elements are sequentially executed. Even if an abnormality occurs during the execution of these sequence processing elements, a recovery processing element corresponding to the timing is executed.

In this embodiment, therefore, as in the first embodiment described above, it is possible to prevent complication of a service application, reduce the labor of development, and ensure the normality of processing for each service.

In the program executing management system according to each of the above embodiments, the arrangement of the individual components can be changed as long as similar actions and functions are achievable. Also, the individual components can be freely combined, and each of these components can be subdivided.

Furthermore, each unit, each element, or each function of the program executing management system according to this embodiment can be written as a program executable by a computer on a recording medium such as a magnetic disk (e.g., a flexible disk or hard disk), optical disk (e.g., CD-ROM or DVD), or semiconductor memory, and thereby applied to a computer system. This program can also be applied to a computer system or server by transmitting the program by a communication medium.

A computer for implementing the aforementioned functions executes the processing described above by loading the program recorded on the recording medium and operates under the control of the loaded program.

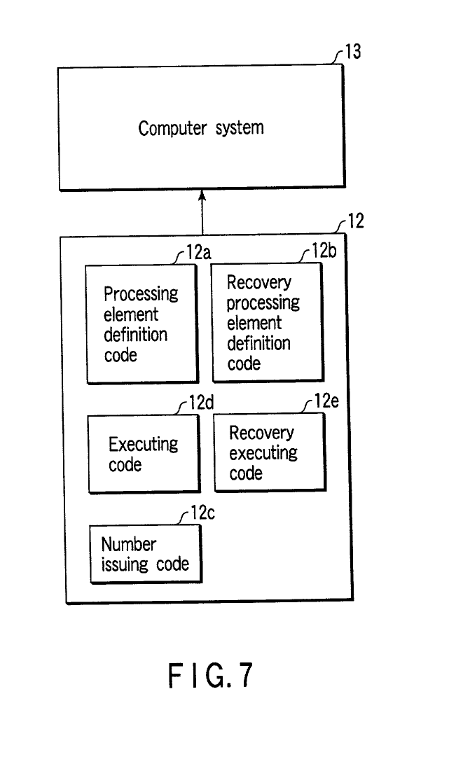

FIG. 7 exemplifies program codes included in a computer program product 12 for implementing operations similar to those of the program executing management system according to each of the above embodiments. These program codes 12a to 12e operate as follows when loaded and executed by a computer system 13.

A processing element definition code 12a stores, for each identification information of an application which uses sequence processing elements, the identification information and the execution order of sequence processing elements to be used by that application.

A recovery processing element definition code 12b stores, for each identification information of a sequence processing element, the identification information of a recovery processing element to be executed when an abnormality occurs.

A number issuing code 12c issues an unique number for each execution request by an application.

An executing code 12d identifies, for each execution request, the operation of an application by using an unique number issued by the number issuing code 12c. This executing code 12d refers to the contents stored by the processing element definition code 12a to detect the identification information of a sequence processing element to be processed next, and executes this sequence processing element corresponding to the detected identification information.

When an abnormality occurs while the executing code 12d is executing a sequence processing element, a recovery executing code 12e refers to the contents stored by the recovery processing element definition code 12b on the basis of the identification information of the sequence processing element that has caused the abnormality.

(Third Embodiment)

In this embodiment, an information processing service provided by the program executing management system described above will be explained.

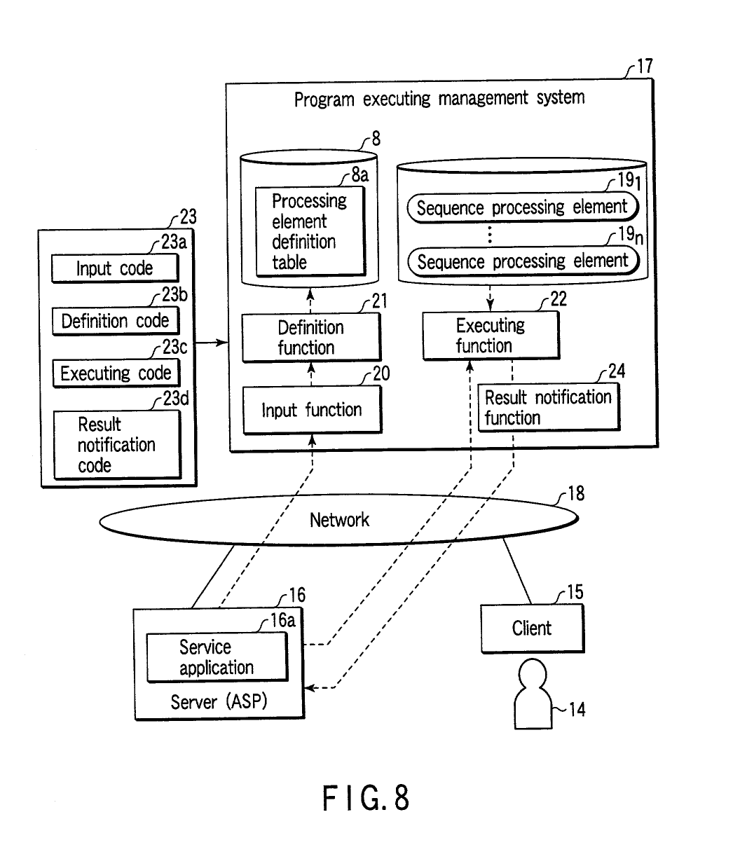

FIG. 8 is a block diagram exemplifying the state of a service provided by the program executing management system.

A client 15 operated by a user 14, a server 16 managed by an ASP (Application Service Provider), and a program executing management system 17 are connected to be able to exchange data with each other via a network 18 such as the Internet. A service application 16a is, e.g., a Web Service.

The program executing management system 17 prestores reusable sequence processing elements 19₁ to 19ₙ. This program executing management system 17 holds reusable sequence processing elements such as a program for accounting management and a program for user authentication.

The program executing management system 17 has an input function 20, a definition function 21, an executing function 22, and a result notification function 24. These input function 20, definition function 21, executing function 22, and result notification function 24 can also be implemented by executing an input code 23a, a definition code 23b, an executing code 23c, and a result notification code 23d loaded from a computer program 23.

The input function 20 receives, in advance, from a person who asks execution by proxy of a sequence processing element via the network 18, information used when the sequence processing element is actually executed by proxy.

Examples of the information necessary for execution by proxy of a sequence processing element are the identification information of a process (the identification information of an application), the identification information of a sequence processing element used in the process, and the execution order of sequence processing elements used in the process.

The definition function 21 prestores information used when a sequence processing element is actually executed by proxy into a processing element definition table 8a of a definition storage unit 8.

The executing function 22 looks up the processing element definition table 8a, when receiving a sequence processing element execution instruction containing the identification information of a process from a person who asks execution by proxy of a sequence processing element via the network 18, and executes the sequence processing element corresponding to the input processing identification information in accordance with the execution order corresponding to the input processing identification information.

The result notification function 24 returns the execution result of a sequence processing element to the service application 16a.

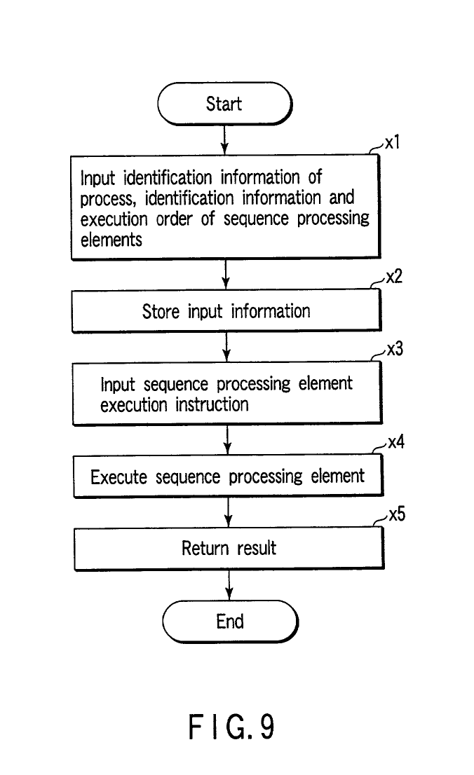

FIG. 9 is a flow chart exemplifying an information processing service provided by the program executing management system 17.

First, the ASP selects sequence processing elements to be used from the reusable sequence processing elements 19₁ to 19ₙ, for the purpose of adding predetermined functions to the service application 16a.

The ASP transmits to the program executing management system 17 the identification information of this service application 16a, the identification information of the selected sequence processing elements, and the execution order of the elements.

The program executing management system 17 receives the information from the ASP by the input function 20 (x1), and stores the information in the processing element definition table 8a by the definition function 21 (x2).

The user 14 operates the client 15 to use the service application 16a of the ASP.

When a sequence processing element execution request event occurs owing to the use of the service application 16a by the user, a sequence processing element execution instruction is transmitted to the program executing management system 17.

The program executing management system 17 receives the sequence processing element execution instruction (x3), executes the sequence processing element requested to be executed by the executing function 22 (x4), and returns the result by the result notification function 24 (x5). The service application performs a process defined according to a predetermined purpose by using the result.

For example, the service application receives information “payment status” from a processing element “accounting management”, and information “access right” from a processing element “user approval”.

If accepting information “payment is being done” from “accounting management” and information “having appropriate access right” from “user approval”, the service application executes the subsequent process.

On the other hand, if accepting information “no payment is being done” from “accounting management” or information “having no access right” from “user approval”, the service application does not execute the subsequent process.

As described above, a new process can be defined and executed by using a processing element.

When the program executing management program 17 according to this embodiment is used as explained above, the reusable sequence processing elements 19₁ to 19ₙ can be freely selected and used.

Accordingly, a person who asks execution by proxy of a sequence processing element can prevent complication of an application, reduce the labor of development, and enrich the functions of an application. Also, a person who asks execution by proxy of a sequence processing element can make the efficiency of maintenance and operation higher than that when the person himself or herself uses a sequence processing element.

On the other hand, the operator of the program executing management system 17 can benefit from a person who asks execution by proxy of a sequence processing element, by executing the sequence processing element by proxy.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A program executing management system comprising:
a processing element definition unit for storing, for each identification information of a process which sequentially uses a plurality of processing elements, the identification information and execution order of a plurality of processing elements used in the process;
a recovery processing element definition unit for storing the identification information of a recovery processing element to be executed when abnormality occurs, for each identification information of the plurality of processing elements;
an executing unit for referring to said processing element definition unit to obtain the identification information of a processing element to be processed next, on the basis of a processing element use request from the process, and executing the processing element corresponding to the obtained identification information; and
a recovery executing unit for, when an abnormality occurs during execution of a processing element by said executing unit, referring to said recovery processing element definition unit on the basis of the identification information of the processing element which has caused the abnormality, and executing a recovery processing element corresponding to the abnormality.

2. A program executing management system according to claim 1, wherein
an application executes the process,
said system further comprises the plurality of processing elements to be sequentially used and an application executing unit for executing the application,
said processing element definition unit stores the identification information and execution order of a plurality of processing elements to be used, for each identification information of an application, and
said executing unit refers to said processing element definition unit to obtain the identification information of a processing element to be processed next, on the basis of a use request from the application, and executes the processing element corresponding to the obtained identification information.

3. A program executing management system according to claim 1, further comprising a number issuing unit for, when an execution request for the process is generated, issuing an unique number corresponding to the execution request,
wherein said executing unit identifies a processing element use request from the process for each unique number issued by said number issuing unit, manages the number of executed processing elements for each unique number, refers to said processing element definition unit on the basis of the number of executed processing elements, obtains the identification information of a processing element to be executed next, and executes the processing element corresponding to the obtained identification information.

4. A program executing management system comprising:
a processing element definition unit for storing, for each identification information of a process which sequentially uses a plurality of processing elements, the identification information and execution order of a plurality of processing elements used in the process;
a recovery processing element definition unit for storing the identification information of a recovery processing element to be executed when abnormality occurs, for each identification information of the plurality of processing elements;
an executing unit for, when an execution request for the process is generated, referring to said processing element definition unit on the basis of the identification information of the process, and sequentially executing a plurality of processing elements corresponding to the identification information of the process in the execution order of the elements; and
a recovery executing unit for, when an abnormality occurs during execution of a processing element by said executing unit, referring to said recovery processing element definition unit on the basis of the identification information of the processing element which has caused the abnormality, and executing a recovery processing element corresponding to the abnormality.

5. A computer-readable computer program product comprising:
an executing code for referring to, on the basis of a process use request from a process which sequentially uses a plurality of processing elements, the identification information and execution order of a plurality of processing elements, stored for each identification information of the process and to be used in the process, obtaining the identification information of a processing element to be processed next, and executing the processing element corresponding to the obtained identification information; and
a recovery executing code for, when an abnormality occurs during execution of a processing element by said executing code, referring to the identification information of a recovery processing element, stored for each identification information of the plurality of processing elements and to be executed when the abnormality has occurred, on the basis of the identification information of the processing element which has caused the abnormality, and executing a recovery processing element corresponding to the abnormality.

6. A computer-readable computer program product according to claim 5, wherein
the process is an application which requests the use of the plurality of processing elements,
said product comprises the plurality of processing elements to be sequentially used and an application executing code for executing the application, and
said executing code refers to the identification information and execution order of a plurality of processing elements, stored for each identification information of the application and to be used in the application, on the basis of a use request from the application, obtains the identification information of a processing element to be processed next, and executes the processing element corresponding to the obtained identification information.

7. A computer-readable computer program product according to claim 5, further comprising a number issuing code for, when an execution request for the process is generated, issuing an unique number corresponding to the execution request,
wherein said executing code identifies a processing element use request from the process for each unique number issued by said number issuing unit, manages the number of executed processing elements for each unique number, refers to the identification information and execution order of a plurality of processing elements stored for each identification information of the process, obtains the identification information of a processing element to be executed next on the basis of the number of executed processing elements, and executes the processing element corresponding to the obtained identification information.

8. A computer-readable computer program product comprising:
an executing code for, when an execution request for a process which sequentially uses a plurality of processing elements is generated, referring to a plurality of processing elements so stored as to correspond to the identification information of the process and the execution order of the elements, and sequentially executing the plurality of processing elements made to correspond to the identification information of the process; and
a recovery executing code for, when an abnormality occurs during execution of a processing element by said executing code, referring to the identification information of a recovery processing element, stored for each identification information of the plurality of processing elements and to be executed when the abnormality has occurred, on the basis of the identification information of the processing element which has caused the abnormality, and executing a recovery processing element corresponding to the abnormality.

9. A computer-readable computer program product comprising:
an executing code for referring to, on the basis of a process use request from a process which sequentially uses a plurality of processing elements, the identification information and execution order of a plurality of processing elements, stored for each identification information of the process and to be used in the process, obtaining the identification information of a processing element to be processed next, and executing the processing element corresponding to the obtained identification information; and
a result notification code for notifying the process of the result of execution of a processing element by said executing code.

10. A computer-readable computer program product comprising:
an input code for inputting the identification information of a process which sequentially executes a plurality of reusable processing elements, the identification information of a plurality of processing elements used in the process, and the execution order of the plurality of processing elements; and
a definition code for storing, for each identification information of the process, the identification information of a plurality of processing elements used in the process, and the execution order of a plurality of processing elements used in the process.

11. A computer-readable computer program product according to claim 10, further comprising:
an executing code for, when the identification information of a process to be executed is input, referring to the contents defined by said definition code, and executing a processing element corresponding to the input identification information of the process in an execution order corresponding to the input identification information of the process; and
a result notification code for notifying the process of the result of execution of a processing element by said executing code.

12. A process executing management method using a computer system, comprising:
the executing step of referring to, on the basis of a process use request from a process which sequentially uses a plurality of processing elements, the identification information and execution order of a plurality of processing elements, stored for each identification information of the process and to be used in the process, obtaining the identification information of a processing element to be processed next, and executing the processing element corresponding to the obtained identification information; and
the result notification step of notifying the process of the execution result of a processing element obtained in the executing step.

13. A process executing management method using a computer system, comprising:
the input step of inputting the identification information of a process which sequentially executes a plurality of reusable processing elements, the identification information of a plurality of processing elements used in the process, and the execution order of the plurality of processing elements; and
the definition step of storing, for each identification information of the process, the identification information of a plurality of processing elements used in the process, and the execution order of a plurality of processing elements used in the process.

14. A method according to claim 13, further comprising:
the executing step of, when the identification information of a process to be executed is input, referring to the contents defined in the definition step, and executing a processing element corresponding to the input identification information of the process in an execution order corresponding to the input identification information of the process; and
the result notification of notifying the process of the execution result of a processing element obtained in the execution step.
